(19) United States
(12) Patent Application Publication
(10) Pub. No.: US 2019/0107717 A1
(43) Pub. Date: Apr. 11, 2019

(54) HEAD-UP DISPLAY SYSTEM

(71) Applicant: VISTEON GLOBAL TECHNOLOGIES, INC., Van Buren Township, MI (US)

(72) Inventors: Sebastien HEINRICH, Schaffhouse-Pres-Seltz (FR); Werner KILLGUSS, Neuweiler (DE)

(21) Appl. No.: 15/725,896

(22) Filed: Oct. 5, 2017

(51) Int. Cl. G02B 27/01; B60K 35/00; G02B 26/08

(52) U.S. Cl. CPC G02B 27/0149; B60K 35/00; G02B 27/0101; G02B 2027/0159; B60K 2350/2052; B60K 2350/30; G02B 26/0816

(57) ABSTRACT

Disclosed herein is a head-up display system includes a motor that has an output shaft that is rotatable about a first axis. A worm gear is connected to and rotatable with the output shaft about the first axis. A cam wheel is rotatable about a second axis and including a plurality of teeth that are meshed with the worm gear to rotate the cam wheel in response to rotation of the worm gear. A mirror is coupled with the cam wheel and moveable in response to rotation of the cam wheel to move a virtual image on a windshield of the vehicle. A lever interconnects the cam wheel and the mirror and provides movement of the mirror in response to rotation of the cam wheel.

### BACKGROUND

A head-up display or HUD is a transparent display that presents information to an operator of a vehicle without requiring the operator to look away from their usual viewpoint. As best illustrated in FIG. 1, a typical HUD system 1 includes an image source 2, e.g., a projector, that projects a virtual image onto one or more mirrors 3 which reflect the virtual image onto a windshield 4 of the vehicle. At least one of the mirrors 2 is typically coupled with a tilt actuator 5 which allows the mirror 3 to be tilted into various positions. For example, the mirror 3 may be tilted in a park position which prevents sun radiation from damaging the image source 2 while the vehicle is parked. Alternatively, the mirror 3 may be titled at various angles such that the virtual image is presented at different locations on the windshield 4 to accommodate different operators.

Conventional tilt actuators include a motor which has an output shaft that is coupled with the mirror. In the case in which the output shaft is directly connected to the mirror, forces therefrom are known to be jarring and excessive and mirror position accuracy is inconsistent. Furthermore, conventional tilt actuator designs typically do not take into account the impact of the force direction between the mirror and the motor output shaft. To address these deficiencies, a complex gear box and big motor are known to be utilized. The mechanical integration of these components can be restrictive, and a big packaging envelope can be needed to contain them.

### SUMMARY

According to an aspect of the disclosure, a head-up display system for a vehicle is provided. The head-up display system includes a motor that has an output shaft that is rotatable about a first axis. A worm gear is connected to and rotatable with the output shaft about the first axis. A cam wheel is rotatable about a second axis and includes a plurality of teeth that are meshed with the worm gear to rotate the cam wheel in response to rotation of the worm gear. A mirror is coupled with the cam wheel and moveable in response to rotation of the cam wheel to move a virtual image on a windshield of the vehicle. A lever interconnects the cam wheel and the mirror and provides movement of the mirror in response to rotation of the cam wheel.

Due to the arrangement of the worm gear, cam wheel and lever, rotational torque from the output shaft of the motor is converted into a push force which provides a simple gear reduction to allow relatively small motors, such as stepper motors, to be utilized to provide rotational movement of the mirror. Furthermore, the assembly is simple in design with few components, inexpensive to manufacture, and lightweight. The assembly is also small in size and thus requires a relatively small packaging space to incorporate into a vehicle.

According to another aspect of the disclosure, a static mirror position is ensured by the irreversibility of the cam wheel against the worm gear or by the static torque of the motor (a high gear ratio provides a high static force of the mirror).

Additional features and advantages of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 is a side schematic view of a vehicle including a conventional head-up display system;

FIG. 2 is a perspective view of an exemplary embodiment of a head-up display system including a tilt actuator and mirror according to an aspect of the disclosure;

FIG. 3 is a side view of the tilt actuator and mirror of the subject exemplary embodiment of a head-up display system;

FIG. 4 is a side view of the tilt actuator and mirror of the subject exemplary embodiment of a head-up display system illustrating the mirror positioned in a park position;

FIG. 5 is a side view of the tilt actuator and mirror of the subject exemplary embodiment of a head-up display system illustrating the mirror positioned in a nominal tilt position;

FIG. 6 is a side view of the tilt actuator and mirror of the subject exemplary embodiment of a head-up display system illustrating the direction of a spring force;

FIG. 7 is a side view of the tilt actuator and mirror of the subject exemplary embodiment of a head-up display system illustrating a situation in which a motor shaft force and spring force are parallel with one another;

FIG. 8 is a side view of the tilt actuator and mirror of the subject exemplary embodiment of a head-up display system illustrating a situation in which a motor shaft force and spring force are pointed in different directions than one another;

FIG. 9 is a perspective view of the tilt actuator and mirror of the subject exemplary embodiment of a head-up display system illustrating the locations of first and second ball joints;

FIG. 10 is a perspective view of the tilt actuator and mirror of the subject exemplary embodiment of a head-up display system illustrating that mechanical alignment between a mirror rotation axis and a cam wheel rotation axis is not required; and

FIG. 11 is a side view of the tilt actuator and mirror of the subject exemplary embodiment of a head-up display system further illustrating that mechanical alignment between the mirror rotation axis and the cam wheel rotation axis is not required.

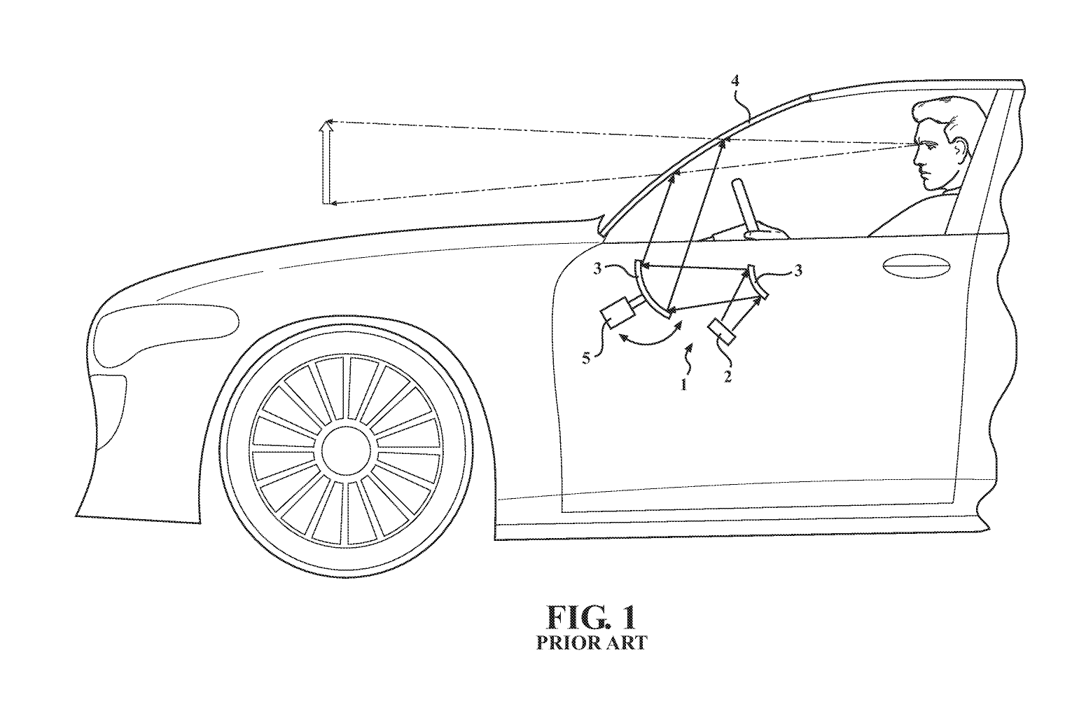

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

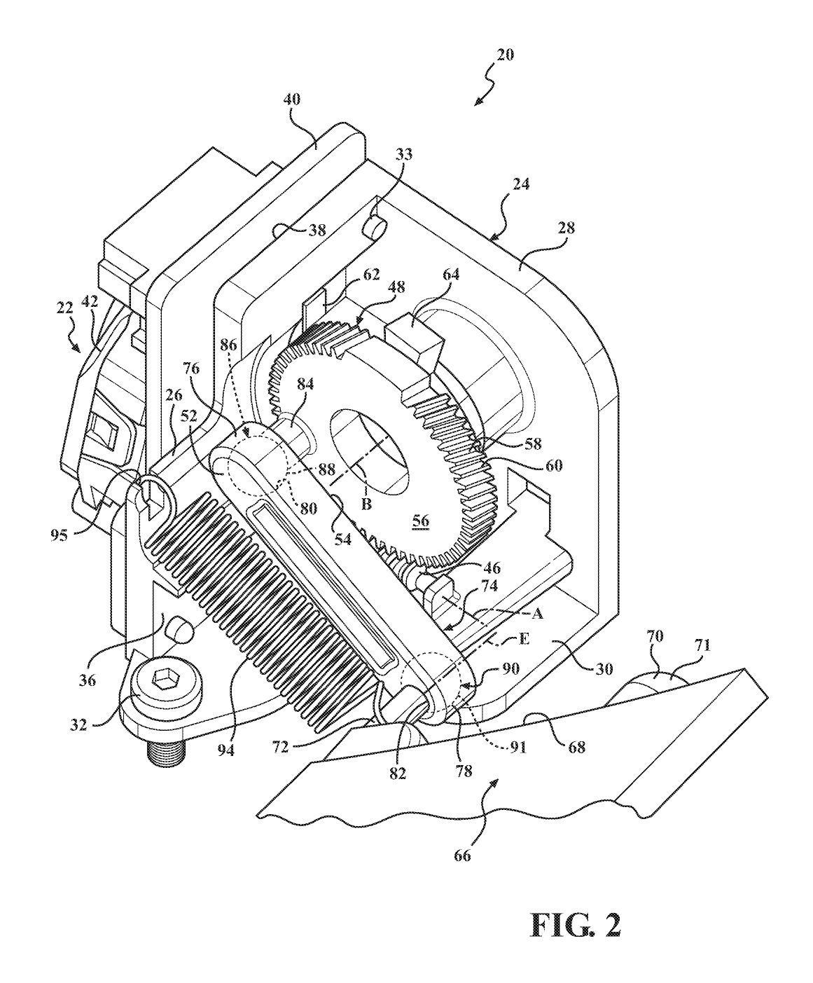

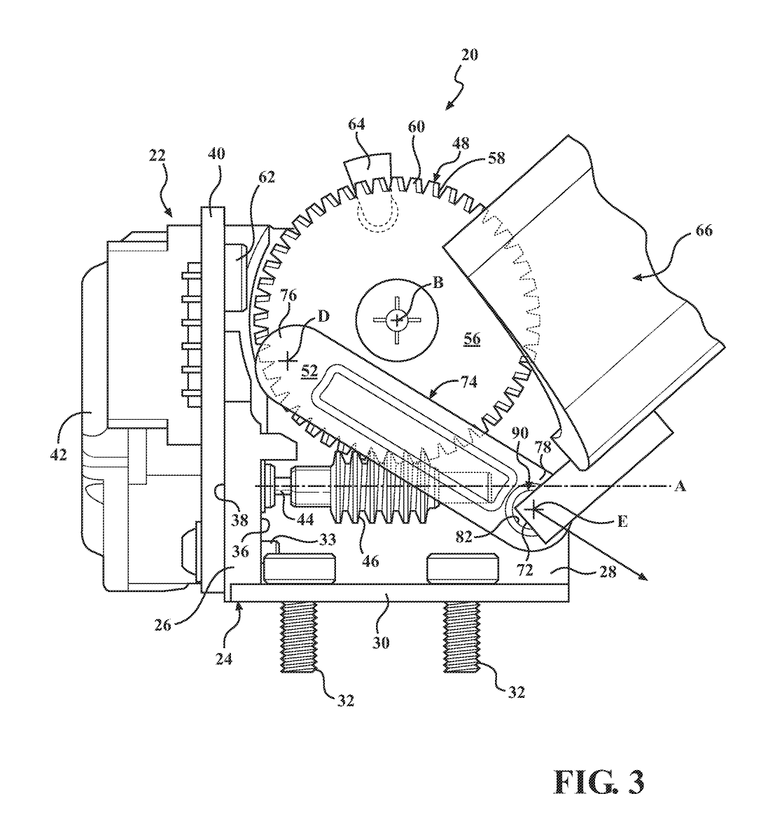

With reference to FIGS. 2-11, a head-up display system 20 for a vehicle is generally shown. As best illustrated in FIG. 2, the head-up display system 20 includes tilt actuator assembly 22 which includes a carrier 24 having a front wall 26, a side wall 28 and a bottom wall 30, all of which are generally perpendicular to one another. A plurality of fasteners 32 extend through the bottom wall 30 for mounting the carrier 24 to mounting location within the dashboard of the vehicle. The front wall 26 has a first surface 36 and a second surface 38 opposite the first surface 36. A printed wiring board 40 overlies the second surface 38. A plurality of fasteners 33 secure the printed wiring board 40 to the front wall 26. A motor 42 overlies and is connected to the printed wiring board 40. As best shown in FIGS. 3-8, the motor 42 includes an output shaft 44 that extends through the printed wiring board 40 and the front wall 26 and protrudes past the second surface 38 of the front wall 26. According the exemplary embodiment, the motor 42 is a stepper motor, but other types of motors may be utilized. The output shaft 44 extends along, and is rotatable about a first axis A. A worm gear 46 is connected to and rotatable with the output shaft 44 about the first axis A.

The tilt actuator assembly 22 further includes a cam wheel 48 which overlies and is rotatably connected to the front wall 26 about a second axis B that is perpendicular to the first axis A. The cam wheel 48 has an inner surface 50 that faces the front wall 26 and an outer surface 56 that faces away from the front wall 26. The cam wheel 48 also has an outer perimeter 58 that presents a plurality of teeth 60 that are meshed with the worm gear 46 such that the cam wheel 48 rotates about the second axis B in response to rotation of the worm gear 46.

The tilt actuator assembly 22 further includes a switch 62 which is disposed against the first surface 36 of the front wall 26 and electrically connected to the motor 42. The switch 62 is configured to stop rotation of the output shaft 44 in response to engagement of the switch 62, i.e., when the switch is activated in a parking mode. A stopping member 64 extends parallel to the second axis B from the inner surface 50 of the cam wheel 48 from a radial location that is adjacent to the outer perimeter 58 of the cam wheel 48. More particularly, the stopping member 64 is radially positioned along the cam wheel 48 such that the cam wheel 48 engages the switch 62 during rotation of the cam wheel 48 to a predetermined angle. As such, when the cam wheel 48 rotates to the predetermined angle, the switch 62 is engaged, thereby stopping rotation of the output shaft 44 and thus the cam wheel 48 with the switch in the parking mode.

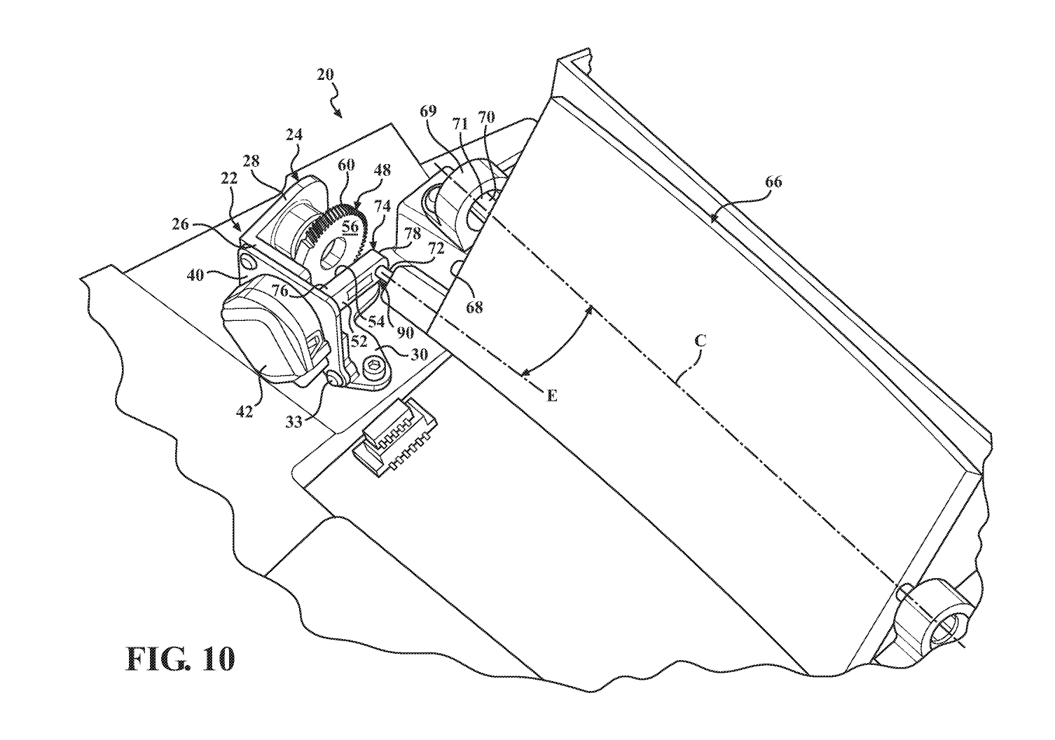

As best illustrated in FIG. 10, a mirror 66 is coupled with the cam wheel 48 and is moveable in response to rotation of the cam wheel 48. The mirror 66 is configured to reflect a virtual image from an image source onto a windshield of the vehicle. Accordingly, movement of the mirror 66 causes movement of the virtual image to different locations of the windshield. The mirror 66 has a side edge 68. A first pivot member 70 extends from the side edge 68 and is pivotably received by fixed mounting element 69 of the vehicle. The first pivot member 70 defines a first mirror pivot point 71 at which the mirror 66 may rotate about a third axis C. A mirror bearing stud 72 extends from the side edge 68 of the mirror 66 at a location that is spaced from the first pivot member 70.

As best illustrated in FIG. 2, the tilt actuator assembly 22 also includes a lever 74 which interconnects the cam wheel 48 and the mirror 66 and provides movement of the mirror 66 in response to rotation of the cam wheel 48. More particularly, the lever 74 converts rotation of the cam wheel 48 into a push force against the mirror 66 to provide movement of the mirror 66. The lever 74 extends between a first end 76 and a second end 78 and has a forward face 52 and a rearward face 54 opposite the forward face 52. The rearward face 54 defines a first socket 80 adjacent to the first end 76, and the forward face 52 defines a second socket 82 adjacent to the second end 78.

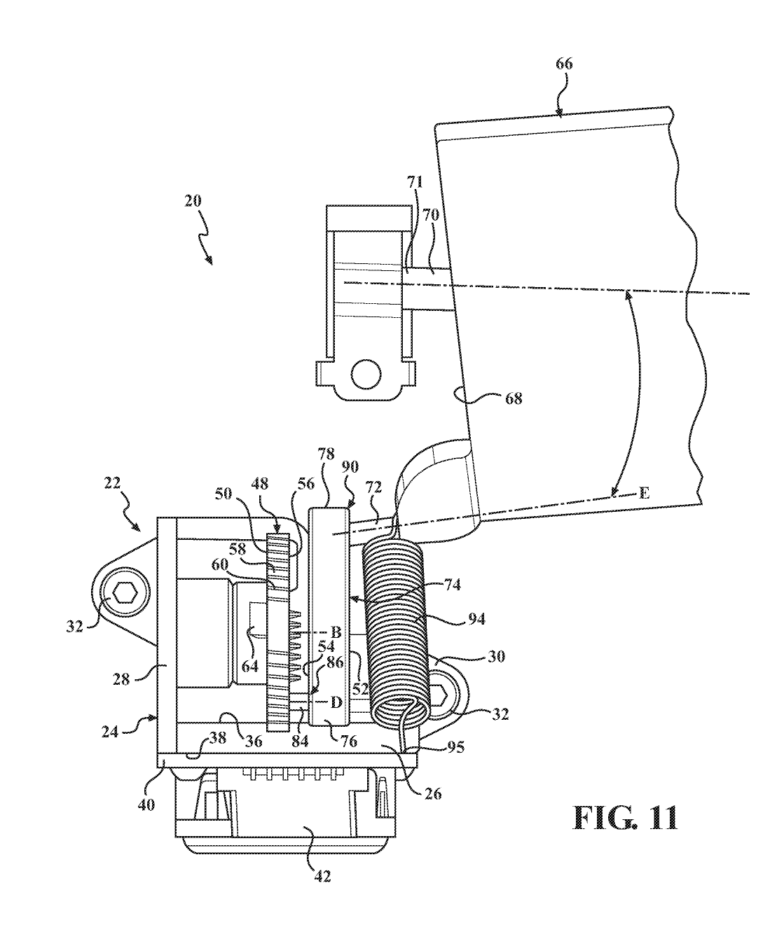

A wheel bearing stud 84 extends from the outer surface 56 of the cam wheel 48 and is received by the first socket 80 of the lever 74 to define a first ball joint 86 to allow pivoting movement of the lever 74 relative to the cam wheel 48 at a first lever pivot point 88 about a fourth axis D (best shown in FIGS. 10 and 11). It should be appreciated that since the first ball joint 86 allows rotation of the lever 74 relative to the cam wheel 48 in various directions, rotation at the first lever pivot point 88 about the fourth axis D advantageously does not have to be parallel with the second axis B of the cam wheel 48.

The mirror bearing stud 72 is received by the second socket 82 of the lever 74 to define a second ball joint 90 to allow pivoting movement of the lever 74 relative to the cam wheel 48 about a fifth axis E at a second mirror pivot point 91. It should be appreciated that since the second ball joint 90 allows rotation of the mirror 66 relative to the lever 74 in various directions, rotation at the second mirror pivot point 91 about the fifth axis E advantageously does not have to be parallel with the second axis B. Accordingly, the combination of the first and second ball joints 86, 90 simplifies mechanical integration of the head-up display system 20 into the vehicle, since no mechanical alignments between the mirror 66 rotation axis (the fourth axis D) and the cam wheel 48 rotation axis (the second axis B) is needed. Mechanical integration of the subject HUD system 20 is therefore simplified.

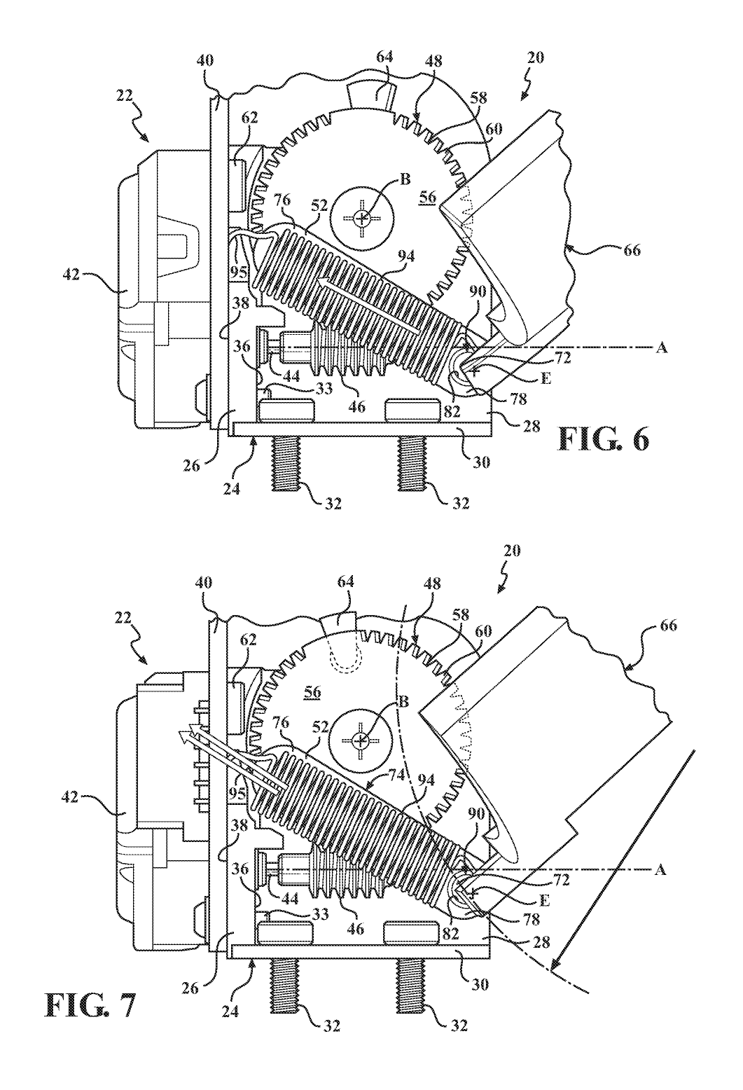

A spring 94 extends between the mirror 66 and a fixed spring mounting location 95. During operation, the spring 94 removes a mechanical clearance in all mechanical connections, and thus removes backlash from the cam wheel 48 and keeps the mirror 66 in a stable position during vibration or mechanical shock of the combiner positioning system, thereby eliminating hysteresis and rattling noise. In the example embodiment, the spring mounting location 95 is defined along the first surface 36 of the front wall 26. It should be appreciated that the spring mounting location 95 could be other locations so long as they are fixed. As best illustrated in FIG. 6 the spring 94 applies a force shown in the direction of the arrow. The spring force applied to the mirror 66 is dependent on the position of the mirror 66 as a result of the length of the spring 94 increasing or decreasing. According to the example embodiment, at a maximum length, the spring force is approximately 2 N. At a minimum length, the spring force is approximately 1.3 N. It should be appreciated that the resulting force of the mirror 66 and spring load is applied to the cam wheel 48 in a specific direction, thus reducing the torque applied to the output shaft 44 of the motor 42. As such, the number of parts of the tilt actuator assembly 22 is reduced relative to conventional tilt actuator assemblies.

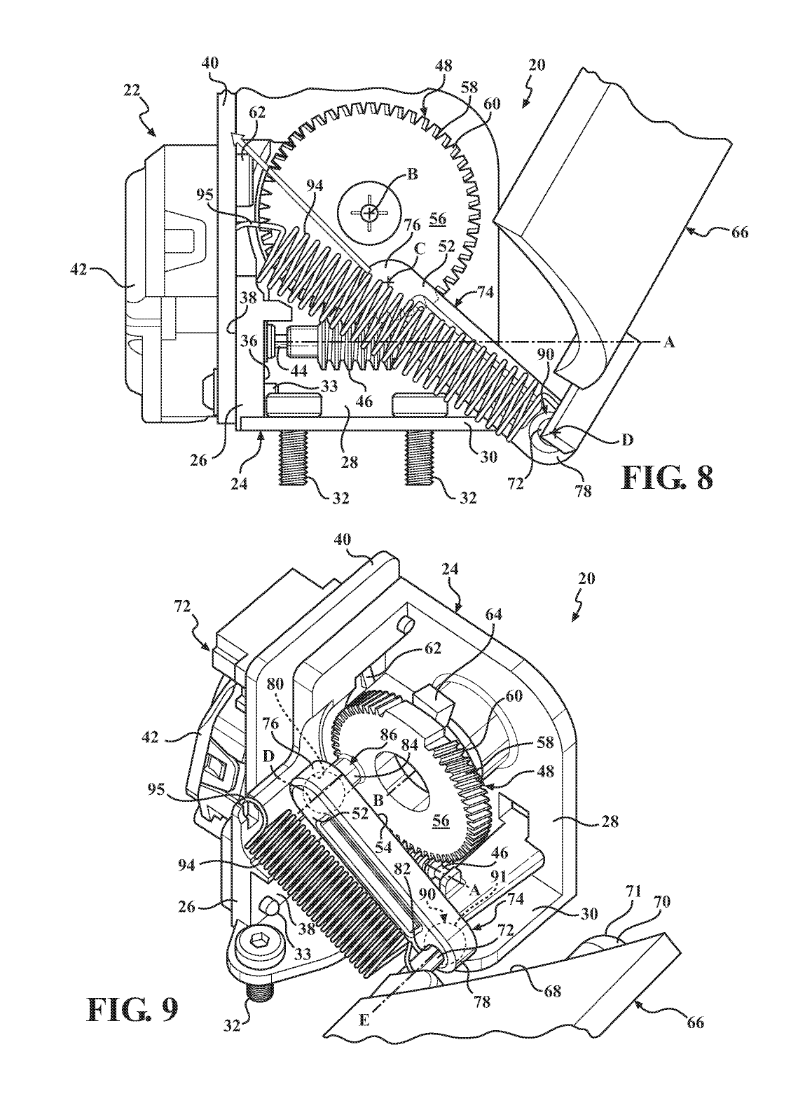

As illustrated by the arrows in FIG. 7, the maximum force transmitted to the motor output shaft 44 occurs when the force from the lever 74 is parallel to the direction of the force from the cam wheel 48. In order to reduce the force transmitted to the motor output shaft 44, the direction of the force from the cam wheel 48 and the direction of the force from the lever 74 are not parallel when the spring force is at its maximum level. As illustrated by the arrows in FIG. 8, the force applied to the motor output shaft 44 is reduced when the force from the lever 74 is not parallel to the force from the cam wheel 48. To ensure that this force is reduced, the position of the first ball joint 86 on the cam wheel 48 is selected to reduce the force transmitted to the motor output shaft 44 when the force of the spring 94 is at its maximum level.

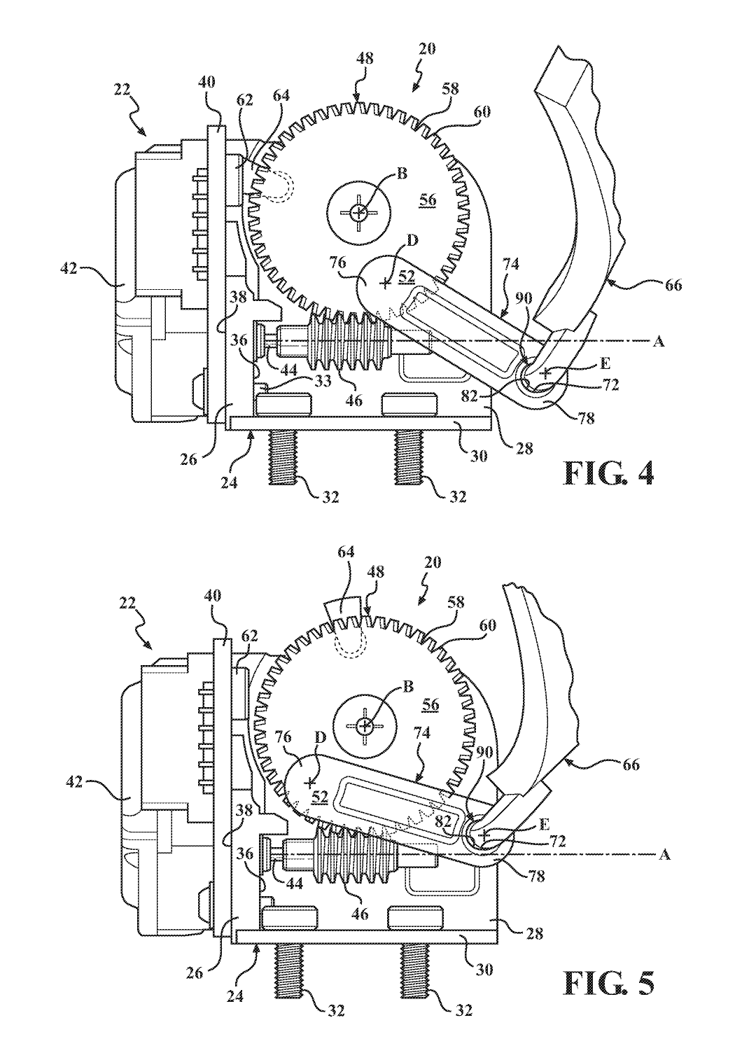

With reference to FIGS. 3-5, during operation of the tilt actuator assembly 22, torque from the output shaft 44 of the motor 42 is converted into a push force against the mirror 66 by way of the worm gear 46, cam wheel 48 and lever 74. The push force (illustrated by the arrow in FIG. 3) provides rotation of the mirror 66 about the fifth axis E. It should be appreciated that once the mirror 66 is stops in a position, it remains static due to irreversibility provided by the worm gear 46. FIG. 4 illustrates the mirror 66 when it is positioned in a park position which prevents sunlight from being emitted directly on the mirror 66. In this position, the stopping member 64 is in engagement with the switch 62 to stop rotation thereof. As such, the output shaft 44 of the motor 42 stops once the mirror 66 has reached the park position. FIG. 5 illustrates the mirror 66 when it is in a nominal tilt position which reflects the virtual image onto the windshield of the vehicle. In this position, the cam wheel 48 is oriented such that the stopping member 64 is out of alignment with the switch 62. It should be appreciated that the mirror 66 may be tilted to other positions adjacent the nominal tilt position by way of minor rotational adjustments of the cam wheel 48 to adjust the location of the virtual image on the windshield.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A head-up display system for a vehicle including:
a motor having an output shaft being rotatable about a first axis;
a worm gear connected to and rotatable with the output shaft about the first axis;
a cam wheel being rotatable about a second axis and including a plurality of teeth being meshed with the worm gear to rotate the cam wheel in response to rotation of the worm gear;
a mirror coupled with the cam wheel and moveable in response to rotation of the cam wheel to move a virtual image on a windshield of the vehicle; and
a lever interconnecting the cam wheel and the mirror and providing the movement of the mirror in response to rotation of the cam wheel.

2. The head-up display system as set forth in claim 1 wherein the second axis is generally perpendicular to the first axis.

3. The head-up display system as set forth in claim 1 wherein the mirror is rotatable about a first mirror pivot point being fixed, and wherein the lever is coupled with the mirror at a second mirror pivot point being moveable and spaced from the first mirror pivot point to provide rotation of the mirror about the first mirror pivot point in response to pushing movement provided by the lever.

4. The head-up display system as set forth in claim 3 wherein the mirror defines a side edge, and wherein the first mirror pivot point and the first lever pivot point are defined adjacent to the side edge of the mirror.

5. The head-up display system as set forth in claim 3 wherein a first ball joint defines the connection between the lever and the cam wheel to allow the lever to rotate about a fourth axis that may be non-parallel with the second axis.

6. The head-up display system as set forth in claim 3 wherein a second ball joint defines the connection between the lever and the mirror to allow the mirror to rotate about a fifth axis that may be non-parallel with the second axis.

7. The head-up display system as set forth in claim 3 wherein a first ball joint defines the connection between the lever and the cam wheel to allow the mirror to rotate about a fourth axis that may be non-parallel with the second axis; and wherein a second ball joint defines the connection between the lever and the mirror to allow the mirror to rotate about a fifth axis at that may be non-parallel with the second axis.

8. The head-up display system as set forth in claim 7 wherein the lever extends between a first end and a second end and presents a forward face and a rearward face opposite the forward face; and wherein the first ball joint is defined adjacent to the first end of the lever and the second ball joint is defined adjacent to the second end of the lever.

9. The head-up display system as set forth in claim 8 wherein the first ball joint includes a first socket defined by the rearward face of the lever adjacent to the first end, and a wheel bearing stud extending from the cam wheel and received by the first socket.

10. The head-up display system as set forth in claim 8 wherein the second ball joint includes a second socket defined by the forward face of the lever adjacent to the second end, and a mirror bearing stud extending from the mirror at the first lever pivot point and received by the second socket.

11. The head-up display system as set forth in claim 1 wherein a spring extends between a spring mounting location being fixed and the mirror to remove backlash from the cam wheel and keep the mirror in a stable position during vibration or mechanical shock of the head-up display system.

12. The head-up display system as set forth in claim 1 further including a carrier supporting the motor.

13. The head-up display system as set forth in claim 12 wherein a spring extends between a spring mounting location on the carrier and the mirror to remove backlash from the cam wheel and keep the mirror in a stable position during vibration or mechanical shock of the head-up display system.

14. The head-up display system as set forth in claim 12 further including a switch electrically connected to the motor and configured to stop rotation of the output shaft of the motor in response to engagement of the switch.

15. The head-up display system as set forth in claim 14 further including a stopping member extending from the cam wheel and radially positioned along the cam wheel such that it engages the switch during rotation of the cam wheel past a certain angle.

16. The head-up display system as set forth in claim 15 wherein the cam wheel has an outer face facing the lever and an inner face opposite the outer face, and wherein the stopping member extends outwardly from the inner face, and wherein the switch is positioned on the carrier.

17. The head-up display system as set forth in claim 12 wherein the carrier has a front wall and a side wall being generally perpendicular to one another, and wherein the motor overlies and is connected to the front wall and the worm gear extends perpendicularly to the front wall, and wherein the cam wheel overlies and is rotatably connected to the side wall.

18. The head-up display system as set forth in claim 17 wherein the front wall has a first surface facing the worm gear and a second surface opposite the first surface, and wherein a printed wiring board overlies the second surface.

19. The head-up display system as set forth in claim 18 wherein the motor overlies and is connected to the printed wiring board, and wherein the output shaft of the motor extends through the printed wiring board and the front wall.

20. The head-up display system as set forth in claim 17 wherein the carrier further includes a bottom wall being generally perpendicular to the front and side walls, and wherein at least one fastener is connected to the bottom wall for connecting the carrier to a mounting surface of the vehicle.
